(19) United States
(12) Patent Application Publication
(10) Pub. No.: US 2020/0412568 A1
(43) Pub. Date: Dec. 31, 2020

(54) DISPLAY CONTROL METHOD AND DISPLAY CONTROL DEVICE

(71) Applicant: Panasonic Intellectual Properly Corporation of America, Torrance, CA (US)

(72) Inventors: Yuki SHINOMOTO, Tokyo (JP); Hiroko SUGIMOTO, Kyoto (JP)

(21) Appl. No.: 17/021,470

(22) Filed: Sep. 15, 2020

Related U.S. Application Data
(63) Continuation of application No. PCT/JP2019/047121, filed on Dec. 3, 2019.

(30) Foreign Application Priority Data
May 16, 2019 (JP) 2019-092925

(51) Int. Cl. H04L 12/28; G06F 3/0481; A47L 11/24

(52) U.S. Cl. CPC H04L 12/2809; G06F 3/0481; H04L 12/2827; H04L 2012/285; H04L 12/2821; A47L 2201/00; A47L 11/24

(57) ABSTRACT

The display control method includes determining whether each of a plurality of home appliances is a first type home appliance installed in a predetermined area or a second type home appliance movable in a plurality of areas based on first information, identifying the area where each of the plurality of home appliances exists based on second information, generating a first display object representing a state of each of the plurality of home appliances based on the first information and the third information, arranging and displaying the first display object of the first type home appliance in a first mode corresponding to the area where each of the first type home appliances is installed, and arranging and displaying the first display object of the second type home appliance in a second mode different from the first mode.

### TECHNICAL FIELD

The present disclosure relates to a technology for displaying a display object indicating a state of a home appliance in a home unit.

### BACKGROUND ART

As a conventional display control method, a technique of Patent Literature 1 below has been known. Patent Literature 1 discloses a technique to obtain the position of a home appliance in a home unit, and display an icon indicating the state of the home appliance by superimposing at the position on a floor plan that corresponds to the position of the home appliance.

However, the conventional display control method has a problem in appropriate display of the state of a self-propelled home appliance such as a robot vacuum cleaner, and further improvement is needed.

### CITATION LIST

### Patent Literature

Patent Literature 1: JP 2017-195550 A

### SUMMARY OF INVENTION

The present disclosure provides a technique for distinguishing between a self-propelled home appliance and a stationary home appliance and appropriately displaying the state of each home appliance.

One aspect of the present disclosure is a display control method performed by a display control device, including obtaining, from each of a plurality of home appliances existing in a home unit, first information that identifies a home appliance, second information that indicates an area where the home appliance is currently installed among a plurality of areas in the home unit, and third information regarding a state of the home appliance, determining whether each of the plurality of home appliances is a first type home appliance installed in a predetermined area among the areas or a second type home appliance movable in the plurality of areas based on the first information, identifying the area where each of the plurality of home appliances exists based on the second information, generating a first display object representing the state of each of the plurality of home appliances based on the first information and the third information, arranging and displaying the first display object of the first type home appliance in a first mode corresponding to the area where each of the first type home appliances is installed, and arranging and displaying the first display object of the second type home appliance in a second mode different from the first mode.

### BRIEF DESCRIPTION OF DRAWINGS

FIG. 1 is a block diagram illustrating an example of a configuration of a home appliance display system according to an embodiment of the present disclosure.

FIG. 2 is a diagram illustrating a layout of rooms constituting a home unit.

FIG. 3 is a diagram illustrating an example of a display screen of an all home appliance display mode and a display screen of an enlarged display mode displayed by a display device.

FIG. 4 is a diagram illustrating an example of a display object.

FIG. 5 is a diagram illustrating an example of display screens in the all home appliance display mode.

FIG. 6 is a diagram illustrating an example of display screens in the enlarged display mode.

FIG. 7 is a diagram illustrating a first example of display screens in the enlarged display mode when a travel plan of a self-propelled home appliance is considered.

FIG. 8 is a diagram illustrating a second example of the display screens in the enlarged display mode when the travel plan of the self-propelled home appliance is considered.

FIG. 9 is a diagram illustrating a third example of the display screens in the enlarged display mode when the travel plan of the self-propelled home appliance is considered.

FIG. 10 is a diagram illustrating an example of a data configuration of a home appliance information table.

FIG. 11 is a diagram illustrating an example of a data configuration of a control command table.

FIG. 12 is a diagram illustrating an example of a data configuration of an operating state table.

FIG. 13 is a diagram illustrating an example of a data configuration of a home appliance table.

FIG. 14 is a diagram illustrating an example of a data configuration of a display device information table.

FIG. 15 is a diagram illustrating an example of a data configuration of a travel plan table.

FIG. 16 is a flowchart illustrating an example of a process of a server when operating state information is received.

FIG. 17 is a flowchart illustrating an example of an all home appliance display mode process.

FIG. 18 is a flowchart illustrating an example of an enlarged display mode process.

FIG. 19 is a flowchart illustrating another example of the enlarged display mode process.

### DESCRIPTION OF EMBODIMENTS

### Knowledge Underlying the Present Disclosure

The present inventor is studying a display device that displays in a list, for example, card-like display objects respectively corresponding to a plurality of home appliances installed in a home unit, and allows a user to check the state of and operate each home appliance through the display objects. A plurality of the display devices is installed in main rooms such as a living room, a dining room, and a sanitary room in a home unit. This display device has, for example, a full screen mode for displaying a list of display objects of all home appliances installed in the home unit and an enlarged display mode for displaying a list of home appliances installed in a certain room.

In the full screen mode, the respective display objects are displayed, for example, separately in multiple groups according to rooms in which corresponding home appliances are installed. In the enlarged display mode, for example, only the display object of a home appliance belonging to the group of the room in which the display device is installed is displayed. Therefore, the user can grasp the installation location of the home appliance corresponding to each display object.

Home appliances installed in a home unit include stationary home appliances such as a refrigerator, a washing machine, and a television, and moreover include in these years a self-propelled home appliance that moves autonomously, such as a robot vacuum cleaner.

Since the positions of the stationary home appliances do not change, display of their display objects is easy in both the full screen mode and the enlarged display mode. However, the position of the self-propelled home appliance varies from time to time, and does not mean that it statically belongs to a certain group. Therefore, how to display the display object of the self-propelled home appliance in both the full screen mode and the enlarged display mode is a problem.

For example, in the enlarged display mode, a mode is conceivable in which the display object of the self-propelled home appliance is displayed if the self-propelled home appliance is located in the same room as the display device, or the display object of the self-propelled home appliance is hidden if the self-propelled home appliance is located in a different room from the display device. However, this makes it utterly impossible for a user who is in a different room from the self-propelled home appliance to grasp the current state of the self-propelled home appliance.

Next, the above-mentioned Patent Literature 1 will be considered. In Patent Literature 1, icons displayed on the floor plan are only the icons of stationary home appliances, and are not the icons of self-propelled home appliances. Thus, Patent Literature 1 cannot properly display the position and state of a self-propelled home appliance. Moreover, Patent Literature 1 displays icons of respective home appliances on a floor plan that two-dimensionally illustrates the state of a room when viewed from above. Thus, in Patent Literature 1, when displaying the icon of the self-propelled home appliance, it is required to move and display the icon in real time according to the position of the self-propelled home appliance. However, this increases the processing cost. Moreover, when the icon of the self-propelled home appliance is moved and displayed on the floor plan in real time, the amount of information on the display screen increases and bothers the user. As a result, it hinders the user to concentrate on performing some work. Thus, the floor plan as illustrated in Patent Literature 1 has a configuration that is not suitable to display of the current state of the self-propelled home appliance.

In order to solve such a problem, the present inventor has acquired knowledge that by differentiating the display mode between the display object of a stationary home appliance and the display object of a self-propelled home appliance, the state of each home appliance can be appropriately displayed in a manner that the stationary home appliance and the self-propelled home appliance are distinguished.

For example, when the self-propelled home appliance is operating in the same room as the display device, a message stating that the self-propelled home appliance is moving in this room is displayed on the display object of the self-propelled home appliance, and when the self-propelled home appliance is operating in a different room from the display device, a message stating that the self-propelled home appliance is moving in another room is displayed on the display object of the self-propelled home appliance. Thus, the state of each home appliance is appropriately displayed in a manner that the stationary home appliance and the self-propelled home appliance are distinguished.

Next, each aspect of the present disclosure will be described.

One aspect of the present disclosure is a display control method performed by a display control device, including obtaining, from each of a plurality of home appliances existing in a home unit, first information that identifies a home appliance, second information that indicates an area where the home appliance is currently installed among a plurality of areas in the home unit, and third information regarding a state of the home appliance, determining whether each of the plurality of home appliances is a first type home appliance installed in a predetermined area among the areas or a second type home appliance movable in the plurality of areas based on the first information, identifying the area where each of the plurality of home appliances exists based on the second information, generating a first display object representing the state of each of the plurality of home appliances based on the first information and the third information, arranging and displaying the first display object of the first type home appliance in a first mode corresponding to the area where each of the first type home appliances is installed, and arranging and displaying the first display object of the second type home appliance in a second mode different from the first mode.

With this configuration, it is determined whether each of the home appliances is a first type home appliance installed in a predetermined area or a second type home appliance movable in the plurality of areas based on the first information that identifies the home appliance. Moreover, an installation area of each of the home appliances is identified based on the second information that indicates an area where each of the home appliances is installed. Furthermore, a first display object representing the state of each of the plurality of home appliances is generated based on the first information and the third information.

Thus, with this configuration, the first display object of each of the home appliances is displayed in association with the area where each of the home appliances is installed. Moreover, with this configuration, the first display object of the first type home appliance is arranged and displayed in the first mode corresponding to the installation area, and the first display object of the second type home appliance is displayed in the second mode different from the first mode. Thus, in the present embodiment, the state of each of the home appliances can be appropriately displayed while distinguishing between the stationary home appliance and the self-propelled home appliance.

The above aspect may be such that the displaying of the first display object includes an all home appliance display mode and an enlarged display mode, the all home appliance display mode causes that the first display objects of all the first type home appliances are arranged and displayed in a first mode, the first display object of the second type home appliance is arranged and displayed in the second mode, and the enlarged display mode causes that the first display object of the first type home appliance installed in a specific area among the plurality of areas is arranged and displayed in a first mode, and the first display object of the second type home appliance is arranged and displayed in the second mode.

With this configuration, in the all home appliance display mode, the first display objects of all the first type home appliances are displayed in the first mode, and the first display object of the second type home appliance is displayed in the second mode. Moreover, in the enlarged display mode, the first display object of the first type home appliance installed in a specific area among the plurality of areas is displayed in the first mode, and the first display object of the second type home appliance is displayed in the second mode. Therefore, in each of the all home appliance display mode and the enlargement mode, the state of the second type home appliance can be appropriately displayed to the user regardless of the current position of the second type home appliance.

The above aspect may be such that the all home appliance display mode causes that a first display device installed in a first area where the second type home appliance is moving displays that the second type home appliance is moving in the first area, and a second display device installed in a second area where the second type home appliance is not moving displays that the second type home appliance is moving in an area other than the second area.

With this configuration, in the all home appliance display mode, a user in the first area in which the second type home appliance is moving can confirm that the second type home appliance is located in the first area. Moreover, in the all home appliance display mode, a user in the second area where the second type home appliance is not moving can confirm that the second type home appliance is located in an area other than the second area.

The above aspect may be such that the enlarged display mode causes that a first display device installed in a first area where the second type home appliance is moving displays a first notification statement stating that the second type home appliance is moving in the first area, and a second display device installed in a second area where the second type home appliance is not moving displays a second notification statement different from the first notification statement for the second type home appliance.

With this configuration, in the enlarged display mode, a user in the first area in which the second type home appliance is moving can confirm through the first notification statement that the second type home appliance is located in the first area. Moreover, in the enlarged display mode, a user in the second area where the second type home appliance is not moving can confirm through the second notification statement different from the first notification statement that the second type home appliance is located in an area other than the second area.

In the above aspect, the second notification statement may indicate that the second type home appliance is moving in an area other than the second area.

With this configuration, in the enlarged display mode, the second display device in the second area where the second type home appliance is not moving displays a second notification statement indicating that the second type home appliance is moving in an area other than the second area. Therefore, the user in the second area can easily confirm that the second type home appliance is located outside the second area.

The above aspect may be such that the second type home appliance moves according to a travel plan that defines an order of moving through the plurality of areas, the second notification statement is displayed on one or more third display devices installed in one or more third areas to which the second type home appliance moves after the first area in the travel plan, and the second notification statement is not displayed on a fourth display device installed in a fourth area to which the second type home appliance does not move after the first area in the travel plan.

With this configuration, when the second type home appliance moves according to the travel plan, a user in a third area to which the second type home appliance moves after the first area where the second type home appliance is moving can confirm through the second notification statement that the second type home appliance is scheduled to move to the third area subsequently. On the other hand, since the second notification statement is not displayed on the fourth display device in the fourth area to which the second type home appliance does not move after the first area, the amount of information displayed on the fourth display device is reduced. Consequently, this configuration can reduce a processing cost of the fourth display device and prevent a user in the fourth area from being notified of unnecessary information.

The above aspect may be such that the second type home appliance moves according to a travel plan that defines an order of moving through the plurality of areas, and when the second type home appliance moves to the second area immediately after the first area in the travel plan, a third notification statement stating that the second type home appliance moves to the second area immediately after the first area is displayed on the second display device.

With this configuration, when the second type home appliance moves according to the travel plan, a user in the second area to which the second type home appliance is to move immediately after the first area can confirm through the third notification statement that this second area is the next destination of the second type home appliance.

The above aspect may be such that the second display device displays a second display object having a function of transmitting to the second type home appliance a command of refusing movement of the second type home appliance to the one or more third areas.

With this configuration, the second display device of where the second type home appliance is not moving displays a second display object for transmitting to the second type home appliance a command of refusing movement of the second type home appliance to the third area to which the second type home appliance is to move after the first area. Therefore, a user can prevent the second type home appliance from moving to the third area at his or her convenience.

The above aspect may be such that the second type home appliance changes the travel plan so as to exclude a third area where movement of the second type home appliance is refused out of the one or more third areas.

With this configuration, since the third area to which movement of the second type home appliance is refused is excluded from the travel plan, a user can change the travel plan just by selecting the second display object.

The present disclosure can also be implemented as a display control program that causes a computer to execute each of characteristic configurations included in such a display control method, or as a display control device that operates by the display control program. Furthermore, it is needless to mention that such a computer program can be distributed via a computer-readable non-transitory recording medium such as a CD-ROM or a communication network such as the Internet.

Note that each of the embodiments described below illustrates a specific example of the present disclosure. Numerical values, shapes, components, steps, order of steps, and the like illustrated in the following embodiments are merely examples, and do not meant to limit the present disclosure. Furthermore, among the components in the following embodiments, components not described in the independent claims indicating the highest concept are described as optional components. Furthermore, in all the embodiments, the respective contents can be combined.

Hereinafter, each of the embodiments of the present invention will be described with reference to the drawings. In the drawings, the same reference numerals are used for the same components.

### EMBODIMENT

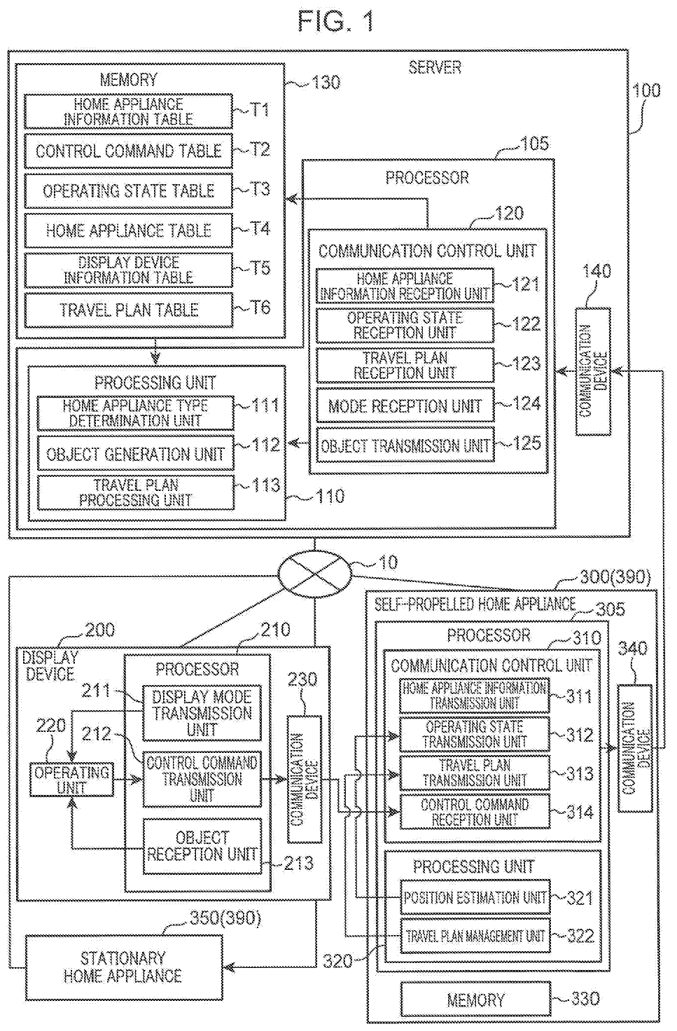

FIG. 1 is a block diagram illustrating an example of a configuration of a home appliance display system according to an embodiment of the present disclosure. The home appliance display system includes a server 100 (display control device), a display device 200, a self-propelled home appliance 300 (second type home appliance), and a stationary home appliance 350 (first type home appliance). Hereinafter, when the self-propelled home appliance 300 and the stationary home appliance 350 are collectively referred to, reference numeral 390 is given to the home appliances. In the following description, it is assumed that there is a plurality of home appliances 390. The home appliance display system is installed in a certain home unit. The home unit is, for example, a single house or an apartment of a collective housing, or the like.

The server 100 controls the display device 200 based on information received from each home appliance 390 installed in the home unit. For example, one server 100 is installed in the home unit.

The display device 200 displays a display object indicating a state of the home appliance 390 installed in the home unit. The display device 200 is installed in each of all or part of a plurality of areas in the home unit. The area is, for example, a room in a home unit such as a living room, a dining room, and a sanitary room. However, this is an example, and the area may be an area in the home unit other than the room, such as a staircase, an entrance, or a corridor.

The self-propelled home appliance 300 is, for example, a robot vacuum cleaner. The self-propelled home appliance 300 autonomously moves in an area of the home unit and periodically transmits the current location area and operating state information to the server 100. One or more self-propelled home appliances 300 are installed in the home unit.

The stationary home appliance 350 is a home appliance 390 for which an installation area is fixed, such as a refrigerator and a TV.

The server 100, the display device 200, and the self-propelled home appliance 300 are communicably connected to each other via a network 10 installed in the home unit. The network 10 is, for example, a wired LAN, a wireless LAN, or a LAN in which a wired LAN and a wireless LAN are mixed.

Next, components of the server 100 will be described. The server 100 includes a processor 105, a memory 130, and a communication device 140.

The processor 105 is, for example, an electric circuit such as a CPU, an ASIC, and an FPGA. The processor 105 includes a processing unit 110 and a communication control unit 120. The processing unit 110 includes a home appliance type determination unit 111, an object generation unit 112, and a travel plan processing unit 113.

The home appliance type determination unit 111 refers to a home appliance information table T1 and determines whether the type of the home appliance 390 is the self-propelled home appliance 300 or the stationary home appliance 350.

The object generation unit 112 generates a display object indicating the state of each home appliance 390 based on a determination result of the home appliance type determination unit 111, the home appliance information table T1, a control command table T2, and an operating state table T3. The object generation unit 112 generates definition information that defines how to arrange generated display objects according to a display mode of the display device 200. The display mode includes, for example, two modes of an all home appliance display mode and an enlarged display mode.

The display object is defined in a markup language, such as extensible markup language (XML) for example, to reduce the amount of data. Therefore, the definition information is also defined in a markup language such as XML.

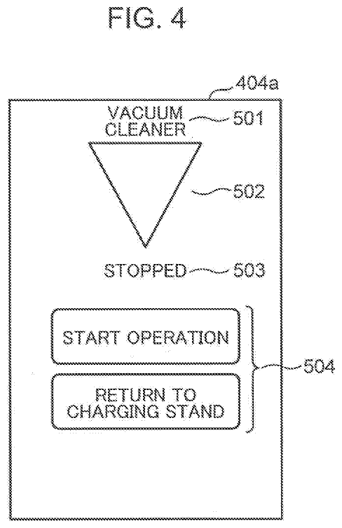

FIG. 4 is a diagram illustrating an example of a display object 404a. The display object 404a exists for each of the plurality of home appliances 390.

The display object 404a includes a name field 501, an icon 502, an operating state field 503, and an operation field 504. The name field 501 displays the name of the home appliance 390 corresponding to the display object 404a. Here, since the home appliance 390 corresponding to the display object 404a is a robot vacuum cleaner, “vacuum cleaner” is displayed in the name field 501. The icon 502 is an icon of the home appliance 390 corresponding to the display object 404a. Here, the icon 502 is configured by an inverted triangle image imitating the appearance of the robot vacuum cleaner. The operating state field 503 displays the operating state of the home appliance 390 corresponding to the display object 404a. Here, since the operating state of the home appliance 390 corresponding to the display object 404a is stopped, “stopped” is displayed in the operating state field 503. The operating state includes, for example, “in operation” in addition to “stopped”.

The operation field 504 displays a button for transmitting a control command to the home appliance 390. Here, a button described as “start operation” for starting operation of the corresponding home appliance 390 and a button described as “return to charging stand” for returning the corresponding home appliance 390 to a charging stand are displayed. Each of the buttons holds the URL of the corresponding home appliance 390 as internal data. Thus, when these buttons are operated by the user, the display device 200 can transmit a control command to the corresponding home appliance 390.

Let us refer back to FIG. 1. The travel plan processing unit 113 calculates a travel scheduled area of the self-propelled home appliance 300 based on travel plan information received by a travel plan reception unit 123 and operating state information of the self-propelled home appliance 300 received by an operating state reception unit 122. The travel scheduled area is, for example, an area where the self-propelled home appliance 300 moves after the area where the self-propelled home appliance 300 is currently moving in a travel plan of the self-propelled home appliance 300.

The communication control unit 120 obtains various information from the display device 200, the self-propelled home appliance 300, and the stationary home appliance 350 via the network 10 by controlling the communication device 140. The communication control unit 120 operates as, for example, a Web server, and publishes a Web API for information transmission to devices in the home unit (including home appliances 390). The device transmits various kinds of information to the communication control unit 120 by calling a published Web API. The communication control unit 120 includes a home appliance information reception unit 121, an operating state reception unit 122, a travel plan reception unit 123, a mode reception unit 124, and an object transmission unit 125.

The home appliance information reception unit 121 receives home appliance information transmitted from the self-propelled home appliance 300 and the stationary home appliance 350 via a Web API for receiving home appliance information. The home appliance information reception unit 121 registers the received home appliance information in the home appliance information table T1.

Moreover, the home appliance information reception unit 121 receives command list information transmitted from the self-propelled home appliance 300 and the stationary home appliance 350 via a Web API for receiving command list information. The home appliance information reception unit 121 registers the received command list information in the control command table T2.

The operating state reception unit 122 receives operating state information transmitted from the self-propelled home appliance 300 and the stationary home appliance 350 via a Web API for receiving operating state information. The operating state reception unit 122 registers the received operating state information in the operating state table T3.

The travel plan reception unit 123 receives travel plan information transmitted from the self-propelled home appliance 300 via a Web API for receiving a travel plan. The travel plan information is information indicating a travel plan of the self-propelled home appliance 300. The travel plan includes, for example, an order of moving through areas for moving the self-propelled home appliance 300. The areas to be moved through may be all areas in the home unit or a part of the areas. The travel plan reception unit 123 registers the received travel plan information in a travel plan table T6.

The mode reception unit 124 receives mode setting information transmitted from the display device 200 via a Web API for receiving mode setting information indicating the display mode set by the user. The mode reception unit 124 registers received mode setting information in a display device information table T5.

The object transmission unit 125 transmits definition information generated by the object generation unit 112 to the display device 200.

The memory 130 is, for example, a nonvolatile storage device such as a flash memory and a hard disk. The memory 130 stores a home appliance information table T1, a control command table T2, an operating state table T3, a home appliance table T4, a display device information table T5, and a travel plan table T6. Details of these tables will be described later.

The communication device 140 is a communication interface such as a wireless LAN and a wired LAN. The communication device 140 transmits various information input from the communication control unit 120 to the display device 200 and the home appliance 390 via the network 10, and inputs various information transmitted from the display device 200 and the home appliance 390 to the communication control unit 120.

The above is the configuration of the server 100.

Next, components of the display device 200 will be described. The display device 200 includes a processor 210, an operating unit 220, and a communication device 230.

The operating unit 220 includes, for example, a display device such as a touch panel and a liquid crystal display. The operating unit 220 displays a display screen including a UI (User Interface) and receives an operation input from the user. The operation input by the user is, for example, an operation for the home appliance 390, an operation of setting the display mode, or the like.

The processor 210 includes a display mode transmission unit 211, a control command transmission unit 212, and an object reception unit 213.

The display mode transmission unit 211 transmits mode setting information of the display object to the mode reception unit 124 of the server 100. The display mode transmission unit 211 transmits the mode setting information to the mode reception unit 124 of the server 100 at the timing when the operating unit 220 receives an operation for setting the display mode. The mode setting information includes information indicating a display mode specified by the user.

When the operating unit 220 receives an operation of selecting an operating button included in a display object of a certain home appliance 390, the control command transmission unit 212 transmits a control command corresponding to the selected operating button to the home appliance 390.

The object reception unit 213 receives definition information transmitted from the object transmission unit 125 of the server 100. The object reception unit 213 operates as a Web server. The object reception unit 213 receives the definition information by publishing a Web API for receiving definition information.

The communication device 230 is a communication interface such as a wireless LAN and a wired LAN. The communication device 230 transmits mode setting information input from the display mode transmission unit 211 to the server 100. The communication device 230 transmits a control command input from control command transmission unit 212 to the home appliance 390. The communication device 230 receives definition information transmitted from the server 100 and inputs the definition information to the object reception unit 213.

The above is the configuration of the display device 200.

Subsequently, a configuration of the self-propelled home appliance 300 will be described. The self-propelled home appliance 300 includes a processor 305, a memory 330, and a communication device 340. The processor 305 is an electric circuit such as a CPU, an ASIC, and an FPGA. The processor 305 includes a communication control unit 310 and a processing unit 320.

The communication control unit 310 includes a home appliance information transmission unit 311, an operating state transmission unit 312, a travel plan transmission unit 313, and a control command reception unit 314.

The home appliance information transmission unit 311 transmits home appliance information defined in the home appliance information table T1 to the home appliance information reception unit 121 of the server 100 via the network 10.

The home appliance information is, for example, transmitted from the self-propelled home appliance 300 to the server 100 when the self-propelled home appliance 300 is initially registered. The initial registration corresponds to, for example, a time when the self-propelled home appliance 300 is used for the first time.

The operating state transmission unit 312 transmits operating state information defined in the operating state table T3 to the operating state reception unit 122 of the server 100 via the network 10. The operating state information includes the current operating state of the self-propelled home appliance 300 and area information indicating the area where the self-propelled home appliance 300 is currently moving, which is input from the position estimation unit 321, and the like. The operating state transmission unit 312 may transmit the operating state information periodically, or may transmit the operating state information when the operating state of the self-propelled home appliance 300 is changed.

The travel plan transmission unit 313 transmits the travel plan information generated by a travel plan management unit 322 to the travel plan reception unit 123 of the server 100 via the network 10. When the travel plan management unit 322 updates the travel plan information, the travel plan transmission unit 313 transmits the updated travel plan information.

The control command reception unit 314 receives a control command transmitted from the control command transmission unit 212 of the display device 200 via the network 10 and executes the control command. The control command includes various information defined in the control command table T2. Note that the control command may be transmitted from the display device 200 to the self-propelled home appliance 300 via the server 100.

The processing unit 320 includes a position estimation unit 321 and a travel plan management unit 322. The position estimation unit 321 estimates the shape of the room and the self-position, or estimates the area where the self-propelled home appliance 300 is currently located, using a technique such as simultaneous localization and mapping (SLAM).

When the self-propelled home appliance 300 moves in the home unit, the position estimation unit 321 generates a home unit map indicating the arrangement of rooms in the home unit, the shapes of the rooms, and the arrangement of obstacles installed in the rooms from sensing data indicating the shapes of all the rooms, and the like. The sensing data is data obtained using, for example, a camera or a distance measurement sensor, which is not illustrated, and the like mounted on the self-propelled home appliance 300. The generated home unit map is displayed on, for example, a mobile terminal or display device 200 owned by the user in the home. The user refers to the displayed home unit map and inputs an area name for each area included in the home unit map. Thus, area correspondence information indicating correspondence between respective areas of the home unit map and area names is generated. The area correspondence information is transmitted from the mobile terminal or the display device 200 to the self-propelled home appliance 300 and stored in the memory 330. Thus, when the position estimation unit 321 estimates the self-position of the self-propelled home appliance 300 in the home unit map, it becomes possible to identify the area name of the area to which the self-position belongs from the area correspondence information.

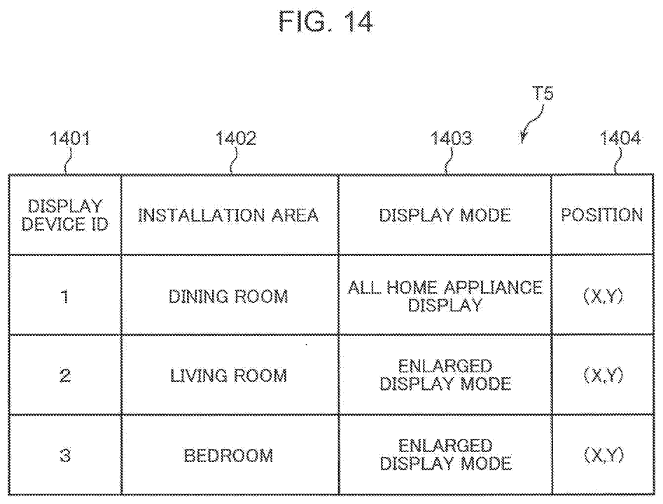

Here, the area correspondence information is generated by input by the user, but this is an example. For example, the position estimation unit 321 may generate the area correspondence information by associating an area name indicated in the installation area of each display device 200 registered in the display device information table T5 with an area to which each display device 200 belongs in the home unit map. Specifically, referring to FIG. 14, the position estimation unit 321 recognizes which display device 200 is installed in each area illustrated in the home unit map from a position 1404 of each display device 200 registered in the display device information table T5. Then, the position estimation unit 321 is just required to associate the area name registered in the installation area 1402 of the display device information table T5 corresponding to the identified display device 200 with each area illustrated in the home unit map, to thereby generate area correspondence information.

The travel plan management unit 322 manages travel plan information of the self-propelled home appliance 300. The travel plan management unit 322 generates travel plan information based on the order of moving through areas of the self-propelled home appliance 300 input by the user using the display device 200 or a portable terminal or the like of the user, for example. When the travel plan is changed, the travel plan management unit 322 updates the travel plan information according to the changed travel plan.

The memory 330 is, for example, a nonvolatile storage device such as a flash memory. The memory 330 stores travel plan information, an operating program of the self-propelled home appliance 300, and the like.

The communication device 340 is a communication interface for a wireless LAN and a wired LAN, or the like. The communication device 340 transmits home appliance information input from the home appliance information transmission unit 311 to the server 100, transmits operating state information input from the operating state transmission unit 312 to the server 100, and transmits travel plan information input from the travel plan transmission unit 313 to the server 100. The communication device 340 receives a control command transmitted from the display device 200 and inputs the control command to the control command reception unit 314.

The above is the configuration of the self-propelled home appliance 300.

The stationary home appliance 350 includes the home appliance information transmission unit 311, the operating state transmission unit 312, and the control command reception unit 314, as well as the memory 330 and the communication device 340, and the like from the configuration of the self-propelled home appliance 300.

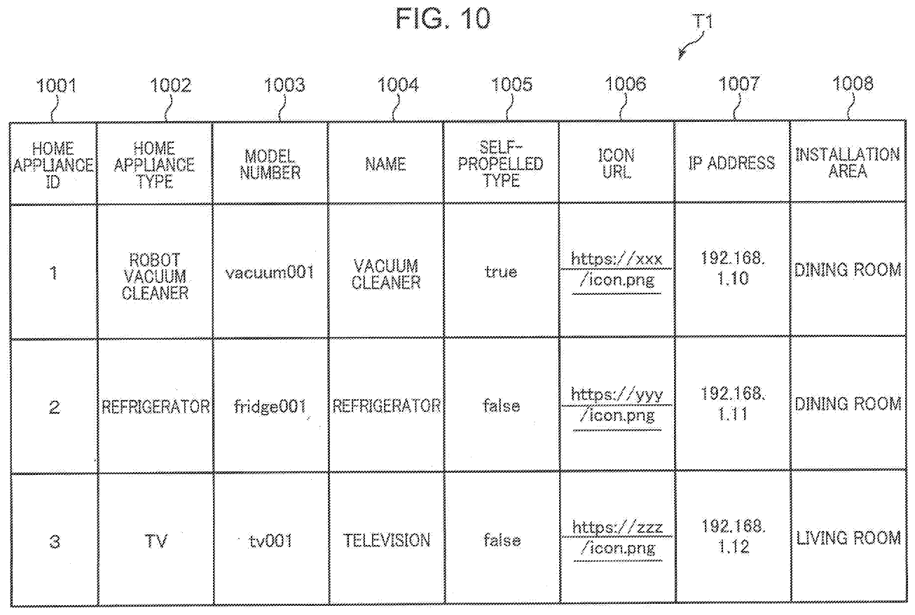

FIG. 10 is a diagram illustrating an example of a data configuration of the home appliance information table T1. The home appliance information table T1 is a database that stores home appliance information transmitted from the home appliance 390 at the time of initial registration, for example. In the home appliance information table T1, home appliance information of one home appliance 390 is registered in one record. The description of the initial registration procedure is omitted.

The home appliance information includes a home appliance ID 1001, a home appliance type 1002, a model number 1003, a name 1004, a self-propelled type 1005, an icon URL 1006, an IP address 1007, and an installation area 1008.

The home appliance ID 1001 indicates an ID (identifier) uniquely assigned to each home appliance 390. The home appliance type 1002 indicates the type of the home appliance 390 such as a robot vacuum cleaner and a refrigerator. The model number 1003 indicates the model number of the home appliance 390. The name 1004 indicates a nickname set to the home appliance by the user. The self-propelled type 1005 indicates whether or not the home appliance 390 is a self-propelled type or a stationary type. In the self-propelled type 1005, true indicates that it is a self-propelled home appliance 300, and false indicates that it is a stationary home appliance 350.

The icon URL 1006 indicates the URL where the image of the icon of the home appliance 390 is stored. The IP address 1007 indicates the IP address of the home appliance 390 in the home network 10 in the home unit. The installation area 1008 indicates an area where the home appliance 390 is installed in the home unit. Note that the installation area 1008 of the self-propelled home appliance 300 indicates an area name that is input at the time of initial registration.

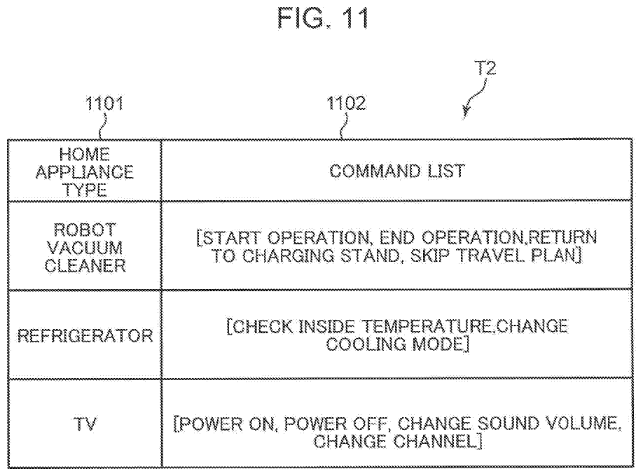

FIG. 11 is a diagram illustrating an example of a data configuration of the control command table T2. The control command table T2 is a database that stores command list information transmitted from the home appliance 390 at the time of initial registration, for example. In the control command table T2, command list information of one home appliance 390 is registered in one record. The command list information includes a home appliance type 1101 and a command list 1102.

The home appliance type 1101 is the same as the home appliance type 1002 in the home appliance information table T1. The command list 1102 illustrates a list of control commands that each home appliance 390 can receive via the network 10. The command list 1102 is defined in advance for each home appliance type. Here, control commands of start operation, end operation, return to charging stand, and skip travel plan are registered as the command list 1102 for the robot vacuum cleaner. Therefore, the user can issue these control commands to the robot vacuum cleaner via the network 10.

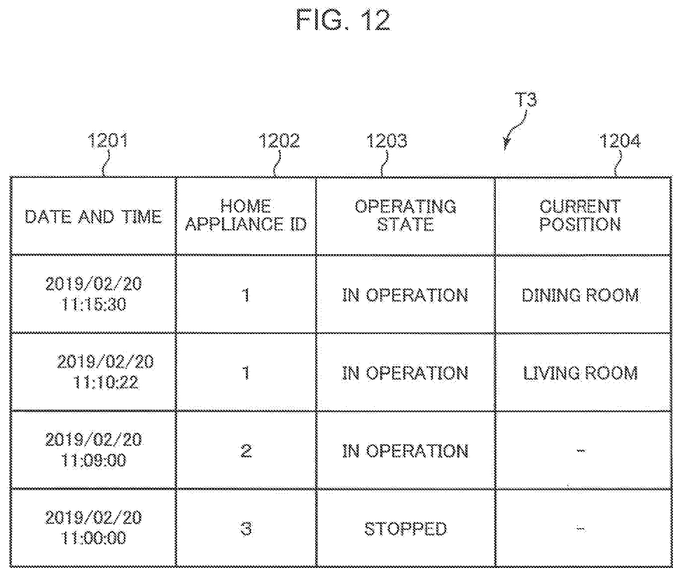

FIG. 12 is a diagram illustrating an example of a data configuration of the operating state table T3. The operating state table T3 is a database that stores operating state information of each home appliance 390. In the operating state table T3, a piece of operating state information is registered in one record. The operating state information includes a date and time 1201, a home appliance ID 1202, an operating state 1203, and a current position 1204.

The date and time 1201 indicates the date and time when the home appliance 390 generated operating state information. Here, an operating state indicated by the latest operating state information of each home appliance 390 is regarded as the current operating state of the home appliance 390.

The home appliance ID 1202 is an ID (identifier) uniquely assigned to each home appliance. By using the home appliance ID 1001 as a key, various types of information registered in the home appliance information table T1 are obtained.

The operating state 1203 indicates an operating state of the home appliance 390. The operating state is, for example, in operation, stopped, charging, and the like.

The current position 1204 indicates an area where the home appliance 390 is moving. For the self-propelled home appliance 300, the current position 1204 indicates the area where it is currently located. As for the stationary home appliance 350, the current position 1204 is set to blank. Note that for the stationary home appliance 350, an installation area may be set for the current position 1204.

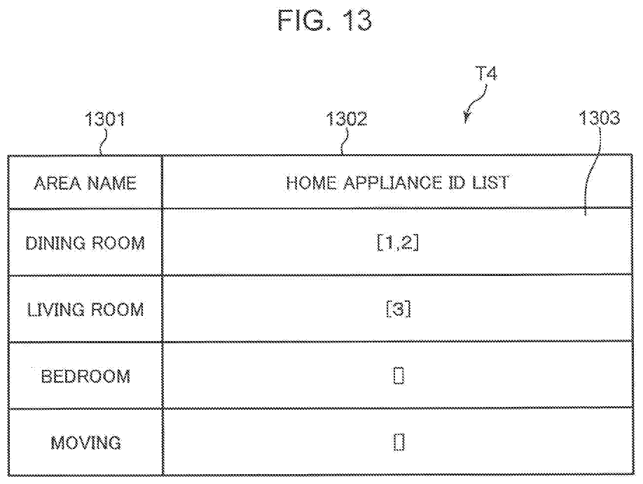

FIG. 13 is a diagram illustrating an example of a data configuration of the home appliance table T4. The home appliance table T4 is a database that stores information indicating which home appliance 390 is located in each area. In the home appliance table T4, one area is associated with one record. The home appliance table T4 includes an area name 1301 and a home appliance ID list 1302.

The area name 1301 indicates an area name. The area name “moving” is not a real area but a virtual area. When the self-propelled home appliance 300 is in operation, the home appliance ID is registered in the “moving” area. The home appliance ID list 1302 illustrates a list of home appliance IDs of the home appliances 390 installed in each area. Here, the home appliance ID list 1302 stores the home appliance IDs of the home appliances 390 installed in each area in an array format.

Although the robot vacuum cleaner with a home appliance ID “1” is a self-propelled home appliance 300, it is currently stopped, and thus the home appliance ID is registered in “dining room” which is the default installation area. When the robot vacuum cleaner becomes operating, the home appliance ID “1” is moved from the home appliance ID list 1302 of the dining room to the moving home appliance ID list 1302. Since the refrigerator with a home appliance ID “2” is a stationary home appliance 350 installed in the dining room, the home appliance ID “2” is registered in the home appliance ID list 1302 of the area name “dining room”. As for the stationary home appliance 350, the home appliance ID registered in the home appliance ID list 1302 does not change as long as moving or the like thereof does not occur. Registration and movement of the home appliance ID in the home appliance table T4 are performed by the operating state reception unit 122.

FIG. 14 is a diagram illustrating an example of a data configuration of the display device information table T5. The display device information table T5 is a database that stores display device information regarding each of the display devices 200 installed in the home unit. In the display device information table T5, one piece of display device information is registered in one record. The display device information includes a display device ID 1401, an installation area 1402, a display mode 1403, and a position 1404.

The display device ID 1401 is an identifier that uniquely identifies the display device 200. The installation area 1402 indicates the area where the display device 200 is installed. The display mode 1403 indicates a display mode of the display device 200 that is currently set. When the display mode is the all home appliance display mode, the display mode 1403 is set to “all home appliance display”, and when the display mode is the enlarged display mode, “enlarged display” is set thereto. The position 1404 indicates the installation position of the display device 200 on the home unit map.

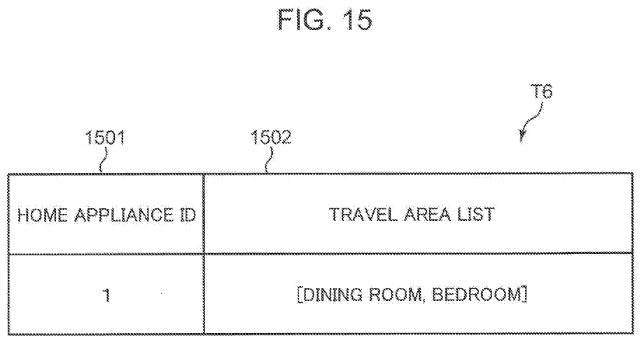

FIG. 15 is a diagram illustrating an example of a data configuration of the travel plan table T6. The travel plan table T6 is a database that stores travel plan information of the self-propelled home appliance 300. In the travel plan table T6, travel plan information of one self-propelled home appliance 300 is registered in one record. The travel plan information includes a home appliance ID 1501 and a travel area list 1502.

The home appliance ID 1501 is an identifier that uniquely identifies the self-propelled home appliance 300. The travel area list 1502 illustrates a list of areas included in the travel plan of the self-propelled home appliance 300. In the travel area list 1502, area names are registered in an array format according to an order of traveling included in the travel plan. Here, a travel plan in which the robot vacuum cleaner 404 travels in the order of “dining room” and “bedroom” is illustrated.

Note that when the travel plan is changed, the travel area list 1502 of the corresponding self-propelled home appliance 300 is updated using the home appliance ID 1501 as a key.

Processes performed by the display control method configured as described above will be described with reference to the drawings.

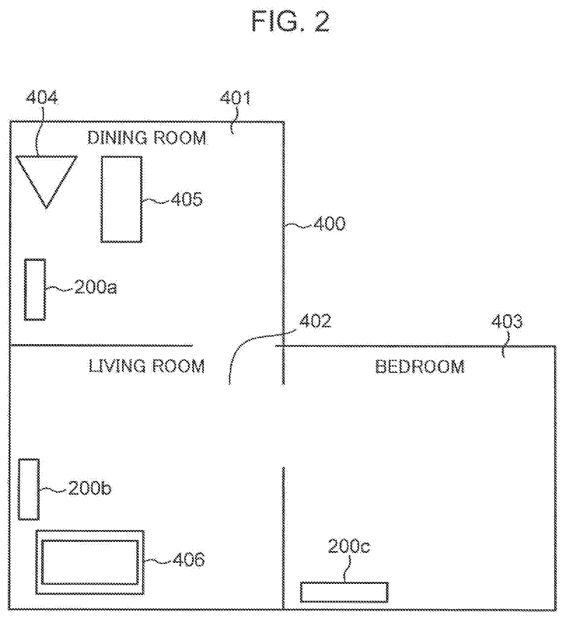

FIG. 2 is a diagram illustrating a layout of rooms constituting a home unit 400. The home unit 400 includes an area of a dining room 401, a living room 402, and a bedroom 403.

In the dining room 401, a display device 200a, a robot vacuum cleaner 404 as a self-propelled home appliance, and a refrigerator 405 as a stationary home appliance are installed. In the living room 402, a display device 200b and a TV 406 as a stationary home appliance are installed. The display device 200c is installed in the bedroom 403.

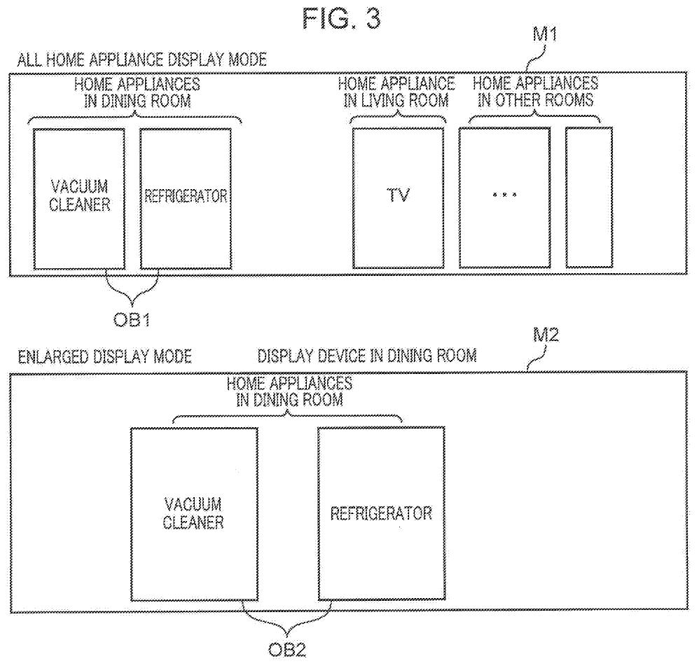

FIG. 3 is a diagram illustrating an example of a display screen of an all home appliance display mode M1 and a display screen of an enlarged display mode M2 displayed by the display device 200.

In the all home appliance display mode M1, display objects OB1 of all home appliances 390 in the home unit are grouped and displayed for each installation area. Here, the display objects OB1 are grouped and displayed for each installation area such as a dining room and a living room. The grouped display objects OB1 are displayed in association with messages indicating the installation area, such as “home appliances in dining room” and “home appliance in living room”. Thus, the user can easily confirm which home appliance 390 is installed in which area. In particular, in the present embodiment, a moving group to which the self-propelled home appliance 300 in operation belongs is included as a group. This will be described later.

Note that in the all home appliance display mode M1, the display order of the grouped display objects OB1 may be, for example, the order of registration in the home appliance information table T1 or the order of operation frequency, and is not particularly limited.

The object generation unit 112 is only required to group all the home appliances 390 registered in the home appliance information table T1 for every area, determine the arrangement order of the home appliances 390 in each group, and arrange the display object OB1 of each home appliance 390 in the arrangement order, to thereby generate definition information of the all home appliance display mode M1. Note that the display order of the groups in the all home appliance display mode M1 may be in descending order of the number of home appliances 390, may be in descending order of the area size, may be in descending order of the number of home appliances 390 whose operation frequency is high, and may be in order such that an area where the display device 200 is installed is given the highest priority, and any order can be employed. Further, the object generation unit 112 determines the state of the home appliance 390 to be displayed on each display object OB1, for example, with reference to the operating state table T3. Moreover, the object generation unit 112 determines an operating button to be displayed on each display object OB1, for example, based on the command list 1102 registered in the control command table T2.

In the enlarged display mode M2, a display object OB2 of the home appliance 390 installed in a specific area is displayed. In the enlarged display mode M2, only a display object OB2 of the home appliance 390 installed in a specific area is displayed. Thus, the display object OB2 in the enlarged display mode M2 can be displayed larger than the display object OB1 in the all home appliance display mode M1. Here, the enlarged display mode M2 of the dining room is illustrated. Here, since the vacuum cleaner and the refrigerator are installed in the dining room, the display objects OB2 of the vacuum cleaner and the refrigerator are displayed. Furthermore, a message indicating the specific area, such as “home appliances in dining room”, is displayed above the display objects OB2. Thus, the user can easily confirm which area is displayed in the enlarged display mode M2. Here, the specific area is, for example, an area where the display device 200 is installed. However, this is an example, and the specific area may be an area arbitrarily selected by the user among all areas in the home unit.

The object generation unit 112 is only required to extract home appliances 390 belonging to a specific area from the home appliance information table T1, determine the arrangement order of the extracted home appliances 390, and arrange the display objects OB2 in the determined arrangement order, thereby generating definition information of the enlarged display mode M2. Moreover, the object generation unit 112 may determine the state of the home appliance 390 and an operating button to be displayed on the display object OB2 in the same manner as in the all home appliance display mode M1. Display contents of the display object OB2 may be the same as those of the display object OB1, or may be more than those of the display object OB1.

The user can switch the display mode by inputting an operation of setting the display mode to the display device 200. When an operation of setting the display mode is input in a certain display device 200, the server 100 switches the display screen of the display object of the corresponding display device 200 to the set display mode.

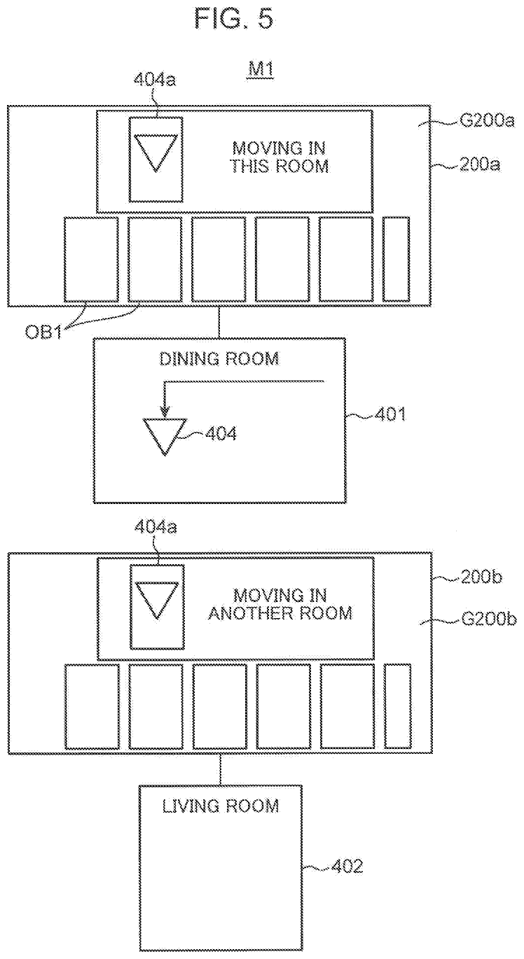

FIG. 5 is a diagram illustrating an example of display screens in the all home appliance display mode M1. In the example of FIG. 5, display screens G200a, G200b displayed by the display devices 200a, 200b when the robot vacuum cleaner 404 is in operation are illustrated. When the robot vacuum cleaner 404 that has stopped in the dining room 401 starts operating, operating state information is transmitted from the robot vacuum cleaner 404 to the server 100, and the object generation unit 112 of the server 100 updates a display object 404a of the robot vacuum cleaner 404.

The robot vacuum cleaner 404 is the self-propelled home appliance 300 and is currently in operation. Accordingly, the display object 404a of the robot vacuum cleaner 404 is moved to the moving group. Here, the current position of the robot vacuum cleaner 404 is the dining room 401. Accordingly, the display device 200a installed in the dining room 401 displays the display object 404a of the robot vacuum cleaner 404 in a different group from the other display objects OB1, and displays a message stating “moving in this room” near the display object 404a. Thus, the user in the dining room 401 can confirm that the robot vacuum cleaner 404 is currently in operation in the dining room 401.

On the other hand, the display device 200b installed in the living room 402 displays a message stating “moving in another room” near the display object 404a because the current position of the robot vacuum cleaner 404 is not the living room 402. Thus, the user in the living room 402 can confirm that the robot vacuum cleaner 404 is currently in operation in another room.

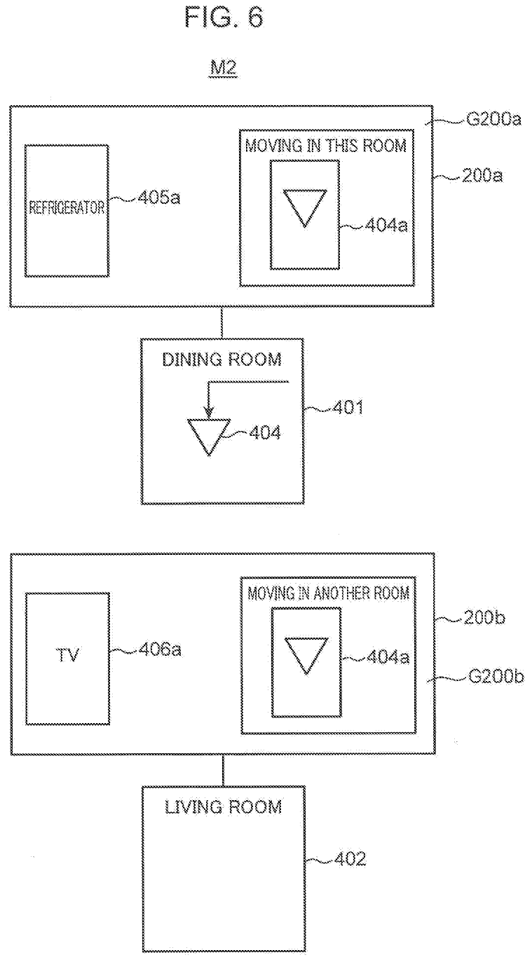

FIG. 6 is a diagram illustrating an example of display screens in the enlarged display mode M2. In the example of FIG. 6, the display screens G200a, G200b displayed by the display devices 200a, 200b when the robot vacuum cleaner 404 is in operation are illustrated. When the robot vacuum cleaner 404 that has been stopped in the dining room 401 starts operating, operating state information is transmitted from the robot vacuum cleaner 404 to the server 100, and the object generation unit 112 of the server 100 updates the display object of the robot vacuum cleaner 404.

The robot vacuum cleaner 404 is the self-propelled home appliance 300 and is currently in operation. Accordingly, the display object 404a of the robot vacuum cleaner 404 is moved to the moving group. Here, the current position of the robot vacuum cleaner 404 is the dining room 401. Accordingly, the display device 200a installed in the dining room 401 displays a message stating “moving in this room” near the display object 404a of the robot vacuum cleaner 404. Thus, the user in the dining room 401 can confirm that the robot vacuum cleaner 404 is currently in operation in the dining room 401. Moreover, the refrigerator 405 is installed in the dining room 401. Accordingly, the display device 200a displays a display object 405a of the refrigerator 405 installed in the dining room 401.

On the other hand, the display device 200b installed in the living room 402 displays a message stating “moving in another room” near the display object 404a because the current position of the robot vacuum cleaner 404 is not the living room 402. Thus, the user in the living room 402 can confirm that the robot vacuum cleaner 404 is currently in operation in another room. Moreover, the TV 406 is installed in the living room 402. Accordingly, the display device 200b displays a display object 406a of the TV 406.

Through the above processing, the user can confirm that the self-propelled home appliance 300 is currently in operation and which area it is moving.

Note that in the examples of FIGS. 5 and 6, the display device 200b displays the message stating “moving in another room” near the display object 404a, but this is an example, and a message stating “moving in dining room” may be displayed near the display object 404a. Thus, the user can directly confirm the area where the robot vacuum cleaner 404 is moving.

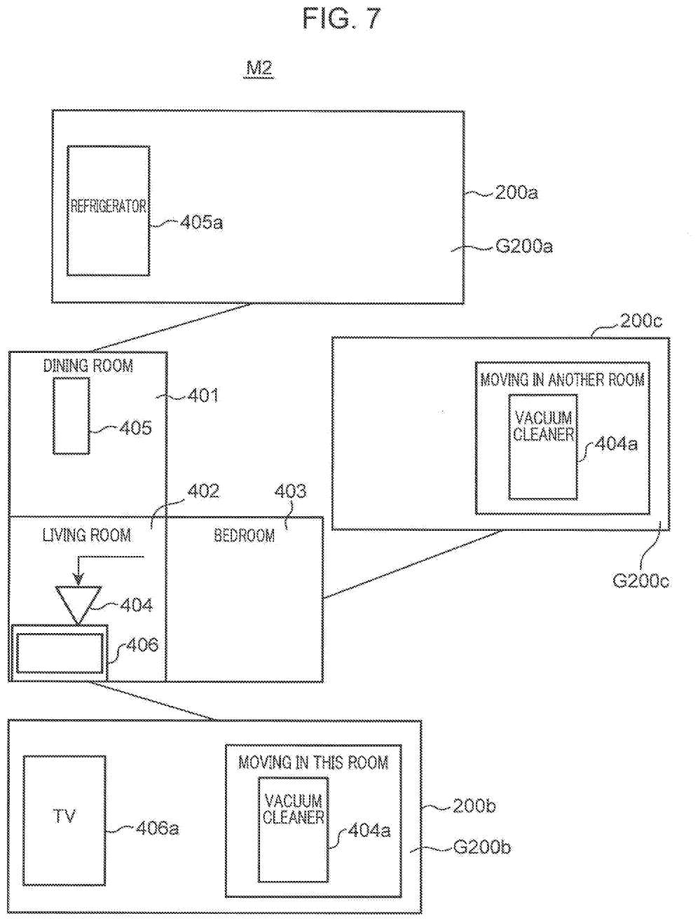

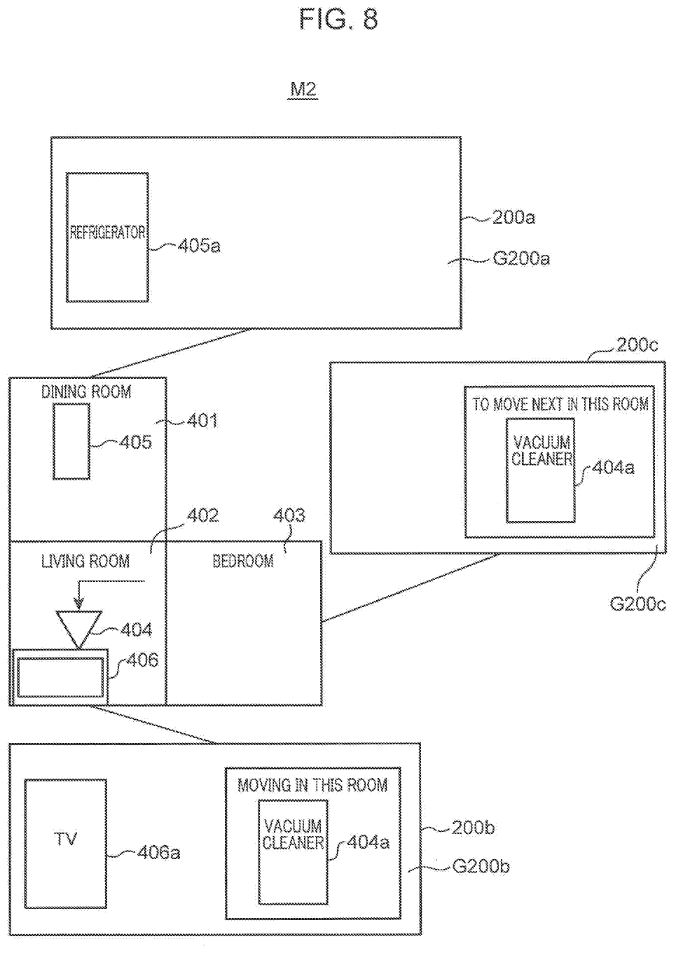

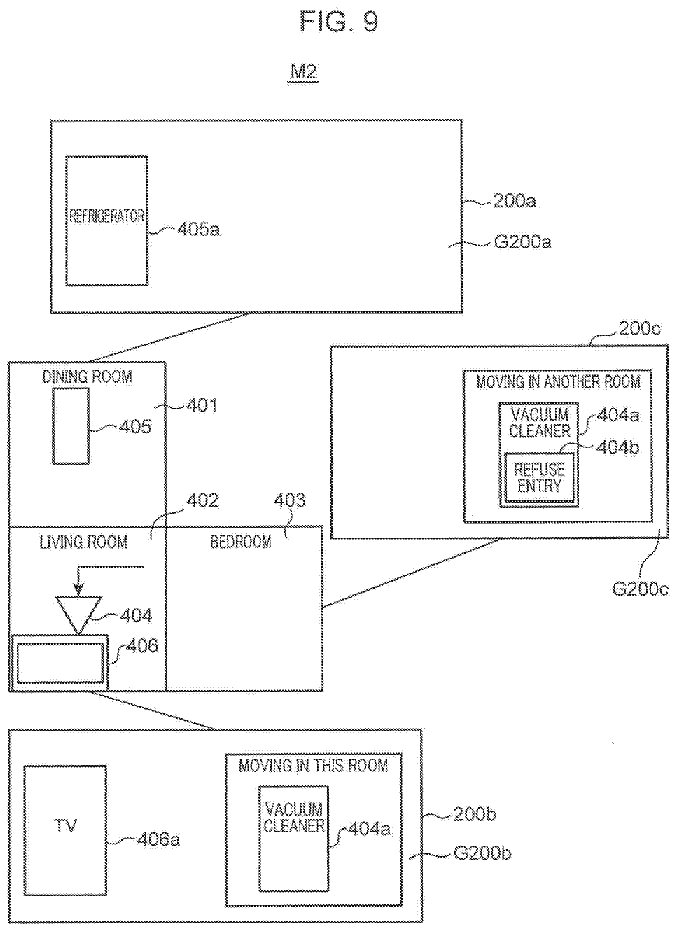

FIG. 7 is a diagram illustrating a first example of display screens in the enlarged display mode M2 when a travel plan of the self-propelled home appliance 300 is considered. Note that in FIG. 7, the same reference numerals are given to portions overlapping with FIG. 6, and descriptions thereof will be omitted. The same applies to FIGS. 8 and 9 described later.

Here, a travel plan to travel in the living room 402 and the bedroom 403 in this order is set to the robot vacuum cleaner 404. Here, the robot vacuum cleaner 404 is currently moving in the living room 402. Accordingly, the display device 200b in the living room displays the display object 404a of the robot vacuum cleaner 404 in the moving group on the display screen G200b, and displays a message stating “moving in this room” near the display object 404a.

In the display device 200c of the bedroom 403, the bedroom 403 belongs to a travel scheduled area. Accordingly, the display device 200c displays the display object 404a of the robot vacuum cleaner 404 in the moving group on the display screen G200c, and displays a message stating “moving in another room” near the display object 404a.

On the other hand, the dining room 401 is not included in the travel plan of the robot vacuum cleaner 404. Accordingly, the display device 200a in the dining room does not display the display object 404a belonging to the moving group on the display screen G200a.

By the above processing, display of unnecessary information for a user in an area where the self-propelled home appliance 300 does not move is avoided.

FIG. 8 is a diagram illustrating a second example of the display screens in the enlarged display mode M2 when the travel plan of the self-propelled home appliance 300 is considered. In the first example, on the display screen G200c of the display device 200c in the bedroom 403, the message stating “moving in another room” is displayed near the display object 404a. On the other hand, in the second example, a message stating “to move next in this room” is displayed on the display screen G200c. Accordingly, the user in the bedroom 403 can confirm that the robot vacuum cleaner 404 is currently in operation in another room and that the robot vacuum cleaner 404 is to move to the bedroom 403 next.

Note that in FIG. 8, if an area after the bedroom 403 is included in the travel plan, the display device 200 in this area is only required to display a message “moving in another room” near the robot vacuum cleaner 404.

FIG. 9 is a diagram illustrating a third example of the display screens in the enlarged display mode M2 when the travel plan of the self-propelled home appliance 300 is considered. In the third example, a user interface (UI) 404b for refusal is displayed on the display object 404a corresponding to the bedroom 403. The configuration of the third example other than this is the same as the first example. The UI 404b for refusal is an operating button for refusing entry of the robot vacuum cleaner 404 to the room.

When the user inputs an operation to select the UI 404b for refusal, the control command transmission unit 212 of the display device 200c transmits a control command to skip the bedroom 403 in the travel plan to the robot vacuum cleaner 404. The robot vacuum cleaner 404 having received this control command skips the bedroom while traveling. Here, since the travel plan includes the living room 402 and the bedroom 403, when the cleaning of the living room 402 is completed, the robot vacuum cleaner 404 returns to, for example, the charging stand. Note that if the travel plan includes an area next to the bedroom 403, the robot vacuum cleaner 404 skips the bedroom 403 and moves to the next area when the cleaning of the living room 402 is completed.

Note that if the travel plan includes one or more areas to which the robot vacuum cleaner 404 is to move after the bedroom 403, the display device 200 installed in the one or more areas may display the UI 404b for refusal. Alternatively, only the display device 200c installed in the bedroom 403 to which it is to move immediately after the living room 402 may display the UI 404b for refusal. Moreover, if one or more areas to which the robot vacuum cleaner 404 is to move after the bedroom 403 are included in the travel plan, the display device 200 in the subsequent areas is only necessary to display a message stating that the robot is moving in another area.

By the above processing, entry of the robot vacuum cleaner 404 can be refused when the user is staying in an area included in the travel plan of the robot vacuum cleaner 404. Note that when an operation of selecting the UI 404b for refusal is input and a travel plan skip control command is transmitted, the robot vacuum cleaner 404 skips traveling in the corresponding area only this time. Therefore, the travel plan of the robot vacuum cleaner 404 registered in the travel plan table T6 illustrated in FIG. 15 is not changed. Consequently, when the robot vacuum cleaner 404 travels according to the travel plan next time, the robot vacuum cleaner 404 does not skip the bedroom 403 unless an operation of selecting the UI 404b for refusal corresponding to the bedroom 403 is input.

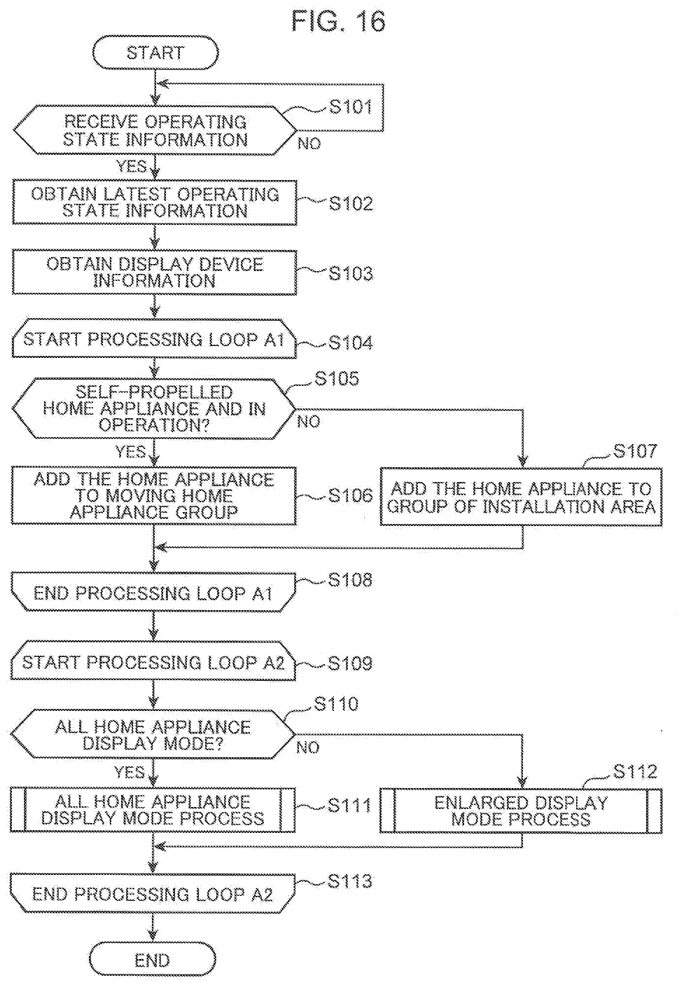

Next, processes of the home appliance display system according to the embodiment of the present disclosure will be described using flowcharts. FIG. 16 is a flowchart illustrating an example of a process of the server 100 when operating state information is received.

In step S101, when the operating state reception unit 122 has received operating state information from a home appliance 390 (YES in step S101), the process proceeds to step S102. On the other hand, when the operating state reception unit 122 has not received the operating state information (NO in step S101), the process returns to step S101 and waits for receiving the operating state information.

In step S102, the object generation unit 112 obtains the latest operating state information for all the home appliances 390 registered in the home appliance information table T1. In this case, the object generation unit 112 may obtain the latest operating state information of all the home appliances 390 by referring to the operating state table T3. Alternatively, the object generation unit 112 may obtain the latest operating state information of each home appliance 390 by transmitting a request to transmit the operating state information to a home appliance 390 other than the home appliance 390 whose operating state information is received in step S101.

In step S103, the object generation unit 112 refers to the display device information table T5, and obtains display device information of all the display devices 200 installed in the home unit.

In step S104, all the home appliances 390 are sequentially set as target home appliances to be processed, and a processing loop A1 for applying the following processing to each target home appliance is started.

In step S105, the home appliance type determination unit 111 determines whether or not the target home appliance is a self-propelled home appliance 300 and is in operation. Here, the home appliance type determination unit 111 determines whether or not the target home appliance is a self-propelled home appliance 300 with reference to the home appliance information table T1. Moreover, the home appliance type determination unit 111 determines whether or not the target home appliance is in operation based on the operating state information obtained in step S102.

If the target home appliance is self-propelled and in operation (YES in step S105), the process proceeds to step S106. If the target home appliance is a stationary home appliance 350 or is stopped (NO in step S105), the process proceeds to step S107.

In step S106, the home appliance type determination unit 111 adds the target home appliance to the moving group by registering the target home appliance in a record of moving of the home appliance table T4. For example, if the target home appliance is a robot vacuum cleaner and is in operation, the home appliance ID “1” of the robot vacuum cleaner is registered in the record of moving of the home appliance table T4. Hereinafter, in the home appliance table T4, a group including the home appliances 390 registered in the record of moving is referred to as a moving group.

In step S107, the home appliance type determination unit 111 registers the target home appliance in the record of the area where the target home appliance is installed in the home appliance table T4, to thereby add the target home appliance to the group of the area where the target home appliance is installed. For example, if the target home appliance is a refrigerator, since the installation area 1008 of the refrigerator in the home appliance information table T1 is “dining room”, the home appliance ID “2” of the refrigerator is added to the record of dining room of the home appliance table T4. Hereinafter, in the home appliance table T4, each group including home appliances 390 registered in each record other than the moving will be referred to as an installation area group.

In step S108, the home appliance type determination unit 111 ends the processing loop A1 if application of the processing loop A1 to all the home appliances has been completed. On the other hand, if application of the processing loop A1 to all the home appliances has not been completed, the home appliance type determination unit 111 sets an unprocessed home appliance 390 as the target home appliance, and returns the process to step S105. Thus, the processing of the processing loop A1 is applied to the next target home appliance.

In step S109, all the display devices 200 are sequentially set as target display devices to be processed, and a processing loop A2 for applying the following processing to each target display device is started.

In step S110, the object generation unit 112 determines whether or not the display mode of the target display device is the all home appliance display mode based on the display device information obtained in step S103. When the display mode of the target display device is the all home appliance display mode (YES in step S110), the process proceeds to step S111. When the display mode of the target display device is not the all home appliance display mode (NO in step S110), the process proceeds to step S112.

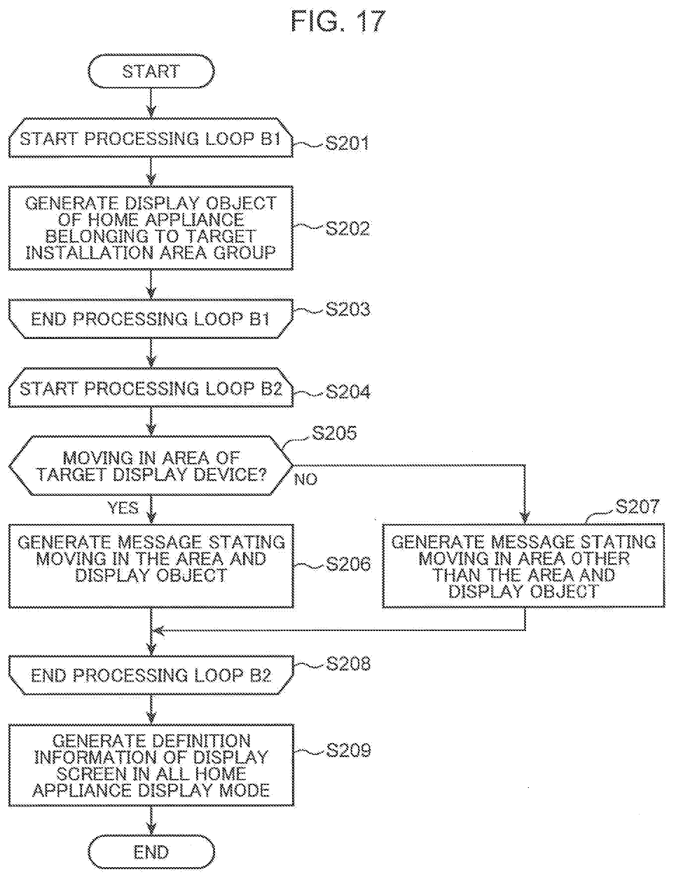

In step S111, the object generation unit 112 executes an all home appliance display mode process for displaying the display screen of the target display device in the all home appliance display mode. Details of the all home appliance display mode process will be described with reference to FIG. 17.

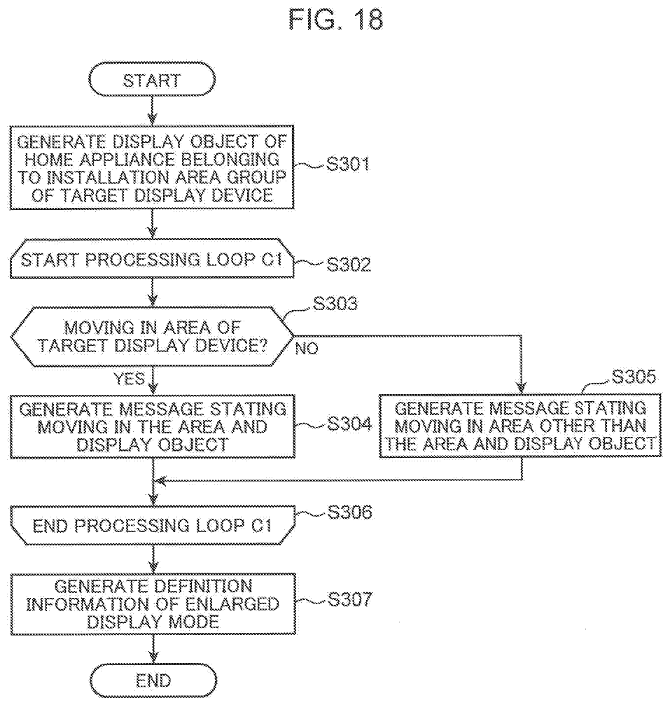

In step S112, the object generation unit 112 executes an enlarged display mode process for displaying the display screen of the target display device in the enlarged display mode. Details of the enlarged display mode process will be described with reference to FIG. 18.

In step S113, if application of the processing loop A2 to all the display devices 200 has been completed, the object generation unit 112 ends the processing loop A2. On the other hand, if application of the processing loop A2 to all the display devices 200 has not been completed, an unprocessed display device 200 is set as the target display device, and the process returns to step S110.

FIG. 17 is a flowchart illustrating an example of the all home appliance display mode process. In step S201, the object generation unit 112 sequentially sets all installation area groups as a target installation area group, and starts a processing loop B1 for applying the following processing to each target installation area group.

In step S202, the object generation unit 112 generates a display object of a home appliance 390 belonging to the target installation area group with reference to the home appliance table T4. In the example of FIG. 13, if the target installation area group is “living room”, a television with a home appliance ID “3” is registered in the “living room”, and thus the display object of the television is generated. In this case, the object generation unit 112 is only required to generate the display object of the television with reference to the operating state information of the television obtained in step S102, and the name 1004 and the icon URL 1006 of the television and the like registered in the home appliance information table T1. This is similarly applied to the display objects of other home appliances 390.

In step S203, if application of the processing loop B1 to all the installation area groups has been completed, the object generation unit 112 advances the process to step S204. On the other hand, if application of the processing loop B1 to all the installation area groups has not been completed, the object generation unit 112 sets an unprocessed installation area group as the target installation area group, and returns the process to step S202.

In step S204, the object generation unit 112 sequentially sets all self-propelled home appliances 300 belonging to the moving group as a target home appliance, and starts a processing loop B2 for applying the following processing to each target home appliance. For example, if the robot vacuum cleaner with the home appliance ID “1” is registered in the record of moving of the home appliance table T4 in FIG. 13, this robot vacuum is set as the target home appliance.

In step S205, the object generation unit 112 determines whether or not the target home appliance is moving in the area where the target display device is installed. If the target home appliance is moving (YES in step S205), the process proceeds to step S206. If the target home appliance is not moving (NO in step S205), the process proceeds to step S207.

For example, assuming that the target display device is the display device 200 in the dining room and the target home appliance is the robot vacuum cleaner with the home appliance ID “1”, if the current position in the latest operating state information of the robot vacuum cleaner obtained in step S102 indicates the dining room, it is determined that the target home appliance is moving in the area where the target display device is installed. On the other hand, if the current position of the latest operating state information of the robot vacuum cleaner obtained in step S102 does not indicate the dining room, it is determined that the target home appliance is not moving in the area where the target display device is installed.

In step S206, the object generation unit 112 generates a message stating that the target home appliance is moving in the area where the target display device is installed, and a display object of the target home appliance. For example, it is assumed that the area where the target display device is installed is the dining room, and the robot vacuum cleaner is moving in the dining room. In this case, as illustrated in the display screen G200a of FIG. 5, the display object 404a of the robot vacuum cleaner and a message stating “moving in this room” are generated.

In step S207, the object generation unit 112 generates a message stating that the target home appliance is moving in an area other than the area where the target display device is installed, and the display object of the target home appliance. For example, if the area where the target display device is installed is the living room and the robot vacuum cleaner is moving in the dining room, as illustrated in the display screen G200b of FIG. 5, the display object 404a of the robot vacuum cleaner and a message stating “moving in another room” are generated.

In step S208, if application of the processing loop B2 to all the home appliances belonging to the moving group has been completed, the object generation unit 112 ends the processing loop B2. On the other hand, if application of the processing loop B2 to all the home appliances belonging to the moving group has not been completed, an unprocessed self-propelled home appliance 300 belonging to the moving group is set as the target home appliance, and the process returns to step S205.

In step S209, the object generation unit 112 generates definition information of the all home appliance display mode for displaying the display objects generated by the above-described processing separately in the installation area group and the moving group, and displays a message stating that it is moving, or the like near the display object of the self-propelled home appliance 300 belonging to the moving group. The generated definition information of the all home appliance display mode is transmitted to the target display device. Thus, the target display device displays the display screens G200a, G200b in the all home appliance display mode as illustrated in FIG. 5.

FIG. 18 is a flowchart illustrating an example of the enlarged display mode process. In step S301, the object generation unit 112 generates a display object of a stationary home appliance 350 belonging to the installation area group corresponding to the area where the target display device is installed. For example, in the example of FIG. 13, if the target installation area group is the living room, the display object of the television with the home appliance ID “3” is generated.

In step S302, the object generation unit 112 sequentially sets all the self-propelled home appliances 300 belonging to the moving group as a target home appliance to be processed, and starts a processing loop C1 for applying the following processing to each target home appliance.

In step S303, the object generation unit 112 determines whether or not the target home appliance is moving in the area where the target display device is installed. If the target home appliance is moving in the area where the target display device is installed (YES in step S303), the process proceeds to step S304. On the other hand, if the target home appliance is not moving in the area where the target display device is installed (NO in step S303), the process proceeds to step S305.

In step S304, the object generation unit 112 generates a message stating that the target home appliance is moving in the area where the target display device is installed, and a display object of the target home appliance. For example, it is assumed that the area where the target display device is installed is the dining room, and the robot vacuum cleaner is moving in the dining room. In this case, as illustrated in the display screen G200a of FIG. 6, the display object 404a of the robot vacuum cleaner and a message stating “moving in this room” are generated.

In step S305, the object generation unit 112 displays a message stating that the target home appliance is moving in an area other than the area where the target display device is installed, and the display object of the target home appliance. For example, it is assumed that the area where the target display device is installed is the living room, and the robot vacuum cleaner is moving in the dining room. In this case, as illustrated in the display screen G200b of FIG. 6, the display object 404a of the robot vacuum cleaner and a message stating “moving in another room” are generated.

In step S306, if application of the processing loop C1 to all the home appliances belonging to the moving group has been completed, the object generation unit 112 ends the processing loop C1. On the other hand, if application of the processing loop C1 to all the home appliances belonging to the moving group has not been completed, an unprocessed self-propelled home appliance 300 belonging to the moving group is set as target home appliances, and the process returns to step S303.

In step S307, the object generation unit 112 generates definition information for displaying the display object, the message, and the like generated by the above-described processing in the enlarged display mode. The generated definition information of the enlarged display mode is transmitted to the target display device. Thus, the target display device displays the display screens G200a, G200b in the enlarged display mode as illustrated in FIG. 6.

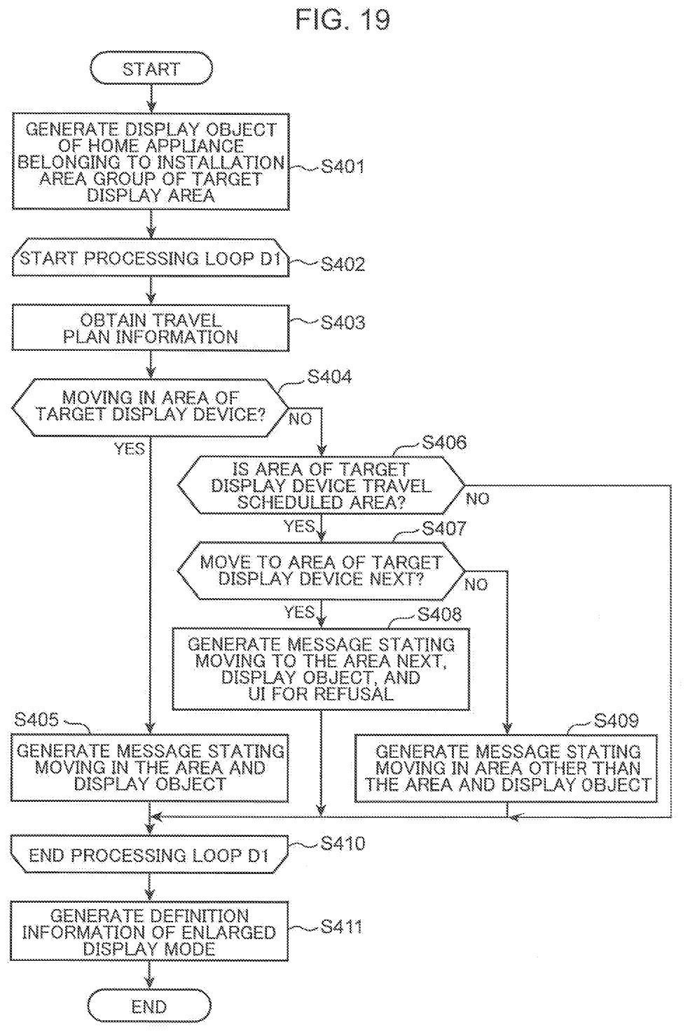

FIG. 19 is a flowchart illustrating another example of the enlarged display mode process. In another example of the enlarged display mode process, the travel plan information of the self-propelled home appliance 300 is referred to. In step S401, the object generation unit 112 generates a display object of the stationary home appliance 350 belonging to the installation area group corresponding to the area where the target display device is installed.

In step S402, the object generation unit 112 sequentially sets all self-propelled home appliances 300 belonging to the moving group as a target home appliance to be processed, and starts a processing loop D1 for applying the following processing to each target home appliance.

In step S403, the object generation unit 112 obtains the travel plan information of the target home appliance by referring to the travel plan table T6.

In step S404, it is determined whether or not the target home appliance is moving in the area where the target display device is installed. If the target home appliance is moving in the area where the target display device is installed (YES in step S404), the process proceeds to step S405. On the other hand, if the target home appliance is not moving in the area where the target display device is installed (NO in step S404), the process proceeds to step S406.

In step S405, the object generation unit 112 generates a message stating that the target home appliance is moving in the area where the target display device is installed, and a display object of the target home appliance.

In step S406, the object generation unit 112 refers to the travel plan information obtained in step S403, and determines whether or not the area where the target display device is installed is included in travel scheduled areas. If the area where the target display device is installed is included in the travel scheduled areas (YES in step S406), the process proceeds to step S408. On the other hand, when the area where the target display device is installed is not included in the travel scheduled areas (NO in step S406), the process proceeds to step S410. For example, it is assumed that the travel plan information indicates a travel plan for traveling in the bedroom after the living room. Moreover, it is assumed that the current position of the target home appliance is the living room. In this case, if the target display device is the display device 200 of the bedroom, it is determined that the bedroom in which the target display device is installed is a travel scheduled area. If the target display device is the display device 200 of other than the bedroom, it is determined that the area where this target display device is installed is not a travel scheduled area.

In step S407, the object generation unit 112 determines whether or not the area where the target display device is installed is the area to which the target home appliance moves next. If this area is the area to which it moves next (YES in step S407), the process proceeds to step S408. On the other hand, if this area is not the area to which it moves next (NO in step S407), the process proceeds to step S409.

In step S408, the object generation unit 112 generates a message stating that the area where the target display device is installed is the area to which the target home appliance moves next, a display object of the target home appliance, and a UI for refusal. For example, it is assumed that the area to which the target home appliance moves next is the bedroom. In this case, the object generation unit 112 generates the display object 404a of the robot vacuum cleaner, a message of “to move next in this room”, and a UI 404b for refusal, as illustrated in a display screen G200c of FIG. 9.

In step S409, the object generation unit 112 generates a message stating that the target home appliance is moving in an area other than the area where the target display device is installed, and the display object of the target home appliance.

In step S410, if application of the processing loop D1 to all the self-propelled home appliances 300 belonging to the moving group has been completed, the object generation unit 112 ends the processing loop D1. On the other hand, if application of the processing loop D1 to all the self-propelled home appliances 300 belonging to the moving group has not been completed, an unprocessed self-propelled home appliance 300 is set as the next target home appliance, and the process returns to step S403.

In step S411, the object generation unit 112 generates definition information for displaying the display object, the message, the UI for refusal, and the like generated by the above-described processing in the enlarged display mode. The generated definition information of the enlarged display mode is transmitted to the target display device.

The above is the contents of processing in the present embodiment.

As described above, by the home appliance display system according to the embodiment, in each of the all home appliance display mode and the enlarged display mode, the display object of the self-propelled home appliance 300 is displayed in a manner different from the display object of the stationary home appliance 350. Therefore, in the present embodiment, the state of each home appliance can be appropriately displayed while distinguishing the stationary home appliance and the self-propelled home appliance.

Note that the configuration of FIG. 1 is summarized as follows.

The home appliance information reception unit 121 and the operating state reception unit 122 correspond to an example of an obtainment unit that obtains, from each of a plurality of home appliances existing in a home unit, first information that identifies a home appliance, second information that indicates an area where the home appliance is currently installed among a plurality of areas in the home unit, and third information regarding a state.

The home appliance ID 1001 in the home appliance information table T1 corresponds to an example of the first information that identifies a home appliance. In the stationary home appliance 350, the installation area 1008 of the home appliance information table T1 corresponds to an example of the second information that indicates an area where the home appliance is currently installed among a plurality of areas in the home unit. In the self-propelled home appliance 300, the current position 1204 of the operating state table T3 corresponds to an example of the second information. Operating state information registered in each record of the operating state table T3 corresponds to an example of the third information regarding the state of the home appliance.

The home appliance type determination unit 111 corresponds to an example of a determination unit that determines whether each of the plurality of home appliances is a first type home appliance installed in a predetermined area among the areas or a second type home appliance movable in the plurality of areas based on the first information.

Moreover, the home appliance type determination unit 111 corresponds to an example of an identification unit that identifies the area where each of the plurality of home appliances exists based on the second information.

The object generation unit 112 corresponds to an example of a generation unit that generates a first display object representing the state of each of the plurality of home appliances based on the first information and the third information.

Moreover, the object generation unit 112 corresponds to an example of a display control unit that arranges and displays the first display object of the first type home appliance in a first mode corresponding to an installation area of each of the first type home appliances, and arranges and displays the first display object of the second type home appliance in a second mode different from the first mode.

The display object of the self-propelled home appliance 300 corresponds to an example of the first display object. The display object of the stationary home appliance 350 corresponds to an example of a second display object.

The mode in which the display objects OB1 of the stationary home appliances 350 are displayed in groups by area in the all home appliance display mode M1 illustrated in FIG. 3 corresponds to an example of the first mode.

The mode in which the display objects OB1 of the stationary home appliances 350 installed in a specific area are displayed in the enlarged display mode M2 illustrated in FIG. 3 corresponds to an example of the first mode.

The mode in which the display object 404a of the robot vacuum cleaner 404 is grouped and displayed in a group different from the display objects OB1 of the stationary home appliances 350 in the all home appliance display mode M1 illustrated in FIG. 5 corresponds to an example of the second mode.

The mode in which the display object 404a is displayed with a message “moving in this room” or a message “moving in another room” added near the display object 404a of the robot vacuum cleaner 404 in the enlarged display mode M2 illustrated in FIG. 6 corresponds to an example of the second mode.

In the all home appliance display mode M1 illustrated in FIG. 5, the dining room 401 where the robot vacuum cleaner 404 is moving corresponds to an example of a first area. At this time, the display device 200a of the dining room 401 corresponds to an example of a first display device.

The living room 402 where the robot vacuum cleaner 404 is not moving in the all home appliance display mode M1 illustrated in FIG. 5 corresponds to an example of a second area. At this time, the display device 200b of the living room 402 corresponds to an example of a second display device.

In the enlarged display mode M2 illustrated in FIG. 6, the dining room 401 where the robot vacuum cleaner 404 is moving corresponds to an example of the first area. At this time, the display device 200a of the dining room 401 corresponds to an example of the first display device. Moreover, at this time, the message “moving in this room” displayed on the display screen G200a of the dining room 401 corresponds to an example of a first notification statement.

In the enlarged display mode M2 illustrated in FIG. 6, the living room 402 where the robot vacuum cleaner 404 is not moving corresponds to an example of the second area. At this time, the display device 200b of the living room 402 corresponds to an example of the second display device. Moreover, at this time, the message “moving in another room” displayed on the display screen G200b of the living room 402 corresponds to an example of a second notification statement.

The bedroom 403 to which the robot vacuum cleaner 404 moves next in the enlarged display mode M2 illustrated in FIG. 7 corresponds to an example of one or more third areas to which the second type home appliance moves after the first area. At this time, the display device 200c of the bedroom 403 corresponds to an example of a third display device.

In the enlarged display mode M2 illustrated in FIG. 7, the dining room 401 not included in the travel plan of the robot vacuum cleaner 404 corresponds to an example of a fourth area to which it does not move after the first area. At this time, the display device 200a of the dining room 401 corresponds to an example of a fourth display device.

The “to move next in this room” displayed on the display device 200c of the bedroom 403 to which the robot vacuum cleaner 404 moves next in the enlarged display mode M2 illustrated in FIG. 8 corresponds to an example of a third notification statement stating that it moves to the second area immediately after the first area.

In the enlarged display mode M2 illustrated in FIG. 9, the UI 404b for refusal displayed by the display device 200c of the bedroom 403 to which the robot vacuum cleaner 404 moves next corresponds to an example of the second display object.

Hereinafter, modification examples of the above embodiment will be described.

(1) The function that the server 100 includes in FIG. 1 may be provided in the display device 200. Note that when a plurality of display devices 200 exists, one of the plurality of display devices 200 is defined as a master display device. Then, the master display device may have the function of the server 100 illustrated in FIG. 1. In this case, the master display device becomes a display control device.

(2) In the present disclosure, the server 100 may detect the position of a self-propelled home appliance 300. At this time, the self-propelled home appliance 300 has a beacon transmission function using a near-field communication technology such as Bluetooth (registered trademark) Low Energy. Furthermore, the display device 200 has a beacon receiving function. While the self-propelled home appliance 300 is moving, the server 100 compares signal strength of a beacon received by the display device 200 in every display device 200. Then, the server 100 may assume the area where the display device 200 having the largest signal strength is installed as the current position of the self-propelled home appliance 300.

(3) In the above embodiment, the object generation unit 112 has been described to generate definition information that defines how to arrange display objects according to the display mode, but the present disclosure is not limited to this. For example, the object generation unit 112 may generate a display screen instead of generating the definition information and transmit the display screen to the display device 200.

### INDUSTRIAL APPLICABILITY

A display control method according to the present disclosure is useful for implementing a function of controlling display of a display object of a self-propelled home appliance in a home unit in a display control device.

1. A display control method performed by a display control device, the method comprising:
obtaining, from each of a plurality of home appliances existing in a home unit, first information that identifies a home appliance, second information that indicates an area where the home appliance is currently installed among a plurality of areas in the home unit, and third information regarding a state of the home appliance;
determining whether each of the plurality of home appliances is a first type home appliance installed in a predetermined area among the areas or a second type home appliance movable in the plurality of areas based on the first information;
identifying the area where each of the plurality of home appliances exists based on the second information;
generating a first display object representing the state of each of the plurality of home appliances based on the first information and the third information;
arranging and displaying the first display object of the first type home appliance in a first mode corresponding to the area where each of the first type home appliances is installed; and
arranging and displaying the first display object of the second type home appliance in a second mode different from the first mode.

2. The display control method according to claim 1, wherein
the displaying of the first display object includes an all home appliance display mode and an enlarged display mode,
the all home appliance display mode causes that the first display objects of all the first type home appliances are arranged and displayed in a first mode,
the first display object of the second type home appliance is arranged and displayed in the second mode, and the enlarged display mode causes that the first display object of the first type home appliance installed in a specific area among the plurality of areas is arranged and displayed in a first mode, and the first display object of the second type home appliance is arranged and displayed in the second mode.

3. The display control method according to claim 2, wherein
the all home appliance display mode causes that
a first display device installed in a first area where the second type home appliance is moving displays that the second type home appliance is moving in the first area, and
a second display device installed in a second area where the second type home appliance is not moving displays that the second type home appliance is moving in an area other than the second area.

4. The display control method according to claim 2, wherein
the enlarged display mode causes that
a first display device installed in a first area where the second type home appliance is moving displays a first notification statement stating that the second type home appliance is moving in the first area, and
a second display device installed in a second area where the second type home appliance is not moving displays a second notification statement different from the first notification statement for the second type home appliance.

5. The display control method according to claim 4, wherein
the second notification statement indicates that the second type home appliance is moving in an area other than the second area.

6. The display control method according to claim 4, wherein
the second type home appliance moves according to a travel plan that defines an order of moving through the plurality of areas,
the second notification statement is displayed on one or more third display devices installed in one or more third areas to which the second type home appliance moves after the first area in the travel plan, and
the second notification statement is not displayed on a fourth display device installed in a fourth area to which the second type home appliance does not move after the first area in the travel plan.

7. The display control method according to claim 4, wherein
the second type home appliance moves according to a travel plan that defines an order of moving through the plurality of areas, and
when the second type home appliance moves to the second area immediately after the first area in the travel plan, a third notification statement stating that the second type home appliance moves to the second area immediately after the first area is displayed on the second display device.

8. The display control method according to claim 6, wherein
the second display device displays a second display object having a function of transmitting to the second type home appliance a command of refusing movement of the second type home appliance to the one or more third areas.

9. The display control method according to claim 8, wherein
the second type home appliance changes the travel plan so as to exclude a third area where movement of the second type home appliance is refused out of the one or more third areas.

10. A display control device comprising:
an obtainment unit that obtains, from each of a plurality of home appliances existing in a home unit, first information that identifies a home appliance, second information that indicates an area where the home appliance is currently installed among a plurality of areas in the home unit, and third information regarding a state of the home appliance;
a determination unit that determines whether each of the plurality of home appliances is a first type home appliance installed in a predetermined area among the areas or a second type home appliance movable in the plurality of areas based on the first information;
an identification unit that identifies the area where each of the plurality of home appliances exists based on the second information;
a generation unit that generates a first display object representing the state of each of the plurality of home appliances based on the first information and the third information; and
a display control unit that arranges and displays the first display object of the first type home appliance in a first mode corresponding to an installation area of each of the first type home appliances, and arranges and displays the first display object of the second type home appliance in a second mode different from the first mode.
